(19) United States
(12) Patent Application Publication
(10) Pub. No.: US 2007/0265881 A1
(43) Pub. Date: Nov. 15, 2007

(54) Xml Application for the Generation of Clinical Trial Forms

(75) Inventors: Khaled M. El Eman, Ottawa (CA); Jonathan Fortye Bermingham Barker, Ottawa (CA)

Correspondence Address: OBLON, SPIVAK, MCCLELLAND MAIER & NEUSTADT, P.C., 1940 DUKE STREET, ALEXANDRIA, VA, 22314, US

(73) Assignee: TRIALSTAT CORPORATION, OTTAWA (CA)

(21) Appl. No.: 10/577,469

(22) PCT Filed: Oct. 20, 2004
(86) PCT No.: PCT/CA04/01893

§ 371 Date: Apr. 23, 2007

Related U.S. Application Data
(60) Provisional application No. 60/515,978, filed on Oct. 29, 2003.

(51) Int. Cl. G06F 19/00

(52) U.S. Cl. 705/3

(57) ABSTRACT

A clinical analytics system is disclosed. A method for generating and displaying a patient form includes retrieving an XML file from a computer-readable medium. The XML file details data and structure of the patient form. The XML file is processed by running an XML-responsive application. The patient form defined by the XML file is generated. The form is displayed on a display.

### RELATED APPLICATION DATA

U.S. Provisional Application No. 60/515,978 filed on Oct. 29, 2003, the contents of which are hereby incorporated by reference.

### FIELD OF THE INVENTION

The present invention relates to a document and data management system and is particularly concerned with a clinical analytics system.

### BACKGROUND OF THE INVENTION

Clinical research document and data management is a growing field. An important aspect of this field is the way in which documents and data are stored and manipulated. Re-usability, portability and interchangeability are desirable attributes for stored documents. Unfortunately, many common document file formats lack these attributes.

Individuals and companies are realizing that extensible markup language (XML) provides a powerful set of tools, so that stored documents can be reusable, portable and interchangeable. XML is a markup language that is more extensible than hypertext markup language (HTML). XML is also a pared-down version of standard generalized markup language (SGML), designed especially for web documents. XML define data inside tagged elements, allowing extraction of data directly into spreadsheets or databases. Because of XML, documents all over the web are moving from an information presentation paradigm to an information database paradigm.

There exist document and data management solutions that take advantage of recent information technology advancements, and that are particularly suited for the clinical research setting. One such solution is disclosed in Kozam et al. (U.S. Pat. No. 6,496,827). In Kozam et al., a remote site computer is connected to an information centre by means of the Internet. A display on the remote site computer can display user interface screens designed using programming languages such as JAVA® and HTML. Interface filters associated with the remote site computer and the primary site server of the information centre perform checks on data that is transmitted over the Internet.

Hotchkiss et al. (U.S. Patent Application No. 2003/0140043 A1) discloses a clinical research data management system and method. A database of the system uses metadata for flexibility, in particular the requirement of modifying the database structure can be avoided permitting implementation of a broad range of study requirements. The published application states that a first data display form can be formatted to render a data set in a first language, and a second display form can be formatted to render the data set in a second language. Data editor functions are disclosed in the patent application including: 1) add/edit study data, and 2) add/edit genetics data. The system of Hotchkiss et al. is designed as a multi-tiered web application. Display forms are meta-data based.

Making changes to and redeploying case report forms (CRFS) and electronic case report forms (eCRFs) is one of the largest contributors to the operation cost of deploying a clinical trial. Trial sites (typically hospitals) tend to be geographically dispersed which complicates the distribution of updated forms in addition to the problem of assuring that all sites are using the latest version. In electronic trial packages of the prior art, changing electronic forms typically entails hand editing HTML and JavaScript® code, updating a database schema, recoding electronic handheld information device (PDA) software and having the sites update their installed software. This process can add months to the length of a clinical trial and can add a great deal of cost to the organization running it.

### SUMMARY OF THE INVENTION

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

According to one example of the invention, a method for generating and displaying a patient form is provided. The method includes:
1. Retrieving an XML file from a computer-readable medium, the XML file detailing data and structure of the patient form;
2. Processing the XML file by running of an XML-responsive application;
3. Generating the patient form defined by the XML file; and
4. Displaying the form on a display.

According to another example of the invention, a computer program product containing a software program is provided. The software program is for installation in a central computer system that is connected to a network. The software program includes code for generating code for a patient form, the patient form defined by an XML file.

According to another example of the invention, a computer program product is provided including a software program. The software program includes code for generating code for a patient form, the patient form defined by an XML file. The software program is for installation in a central computer that is connected to a network.

### BRIEF DESCRIPTION OF THE DRAWINGS

The invention will be further understood from the following detailed description of embodiments of the invention and accompanying drawings in which:

FIG. 1 illustrates a method for generating and displaying a patient form defined by an XML file;

FIG. 2a is a relationship diagram for a patient web form according to an embodiment of the present invention;

FIG. 2b is a relationship diagram for a patient PDA form according to an embodiment of the present invention;

FIG. 3 is a relationship diagram for an embodiment of the clinical analytics system; and

FIG. 4 is a flow diagram illustrating a randomization method according to an embodiment of the present invention.

### DETAILED DESCRIPTION

The present invention will now be described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers.

In an embodiment of the present invention, platform neutral specifications of electronic case report forms (eCRFs) intended for use in a clinical trial are stored in XML format. An XML document is specific to each case report form. (CRF) and includes information such as: dependencies on other CRFs, mapping to database tables, whether duplicate records are allowed for that CRF, a display name for the eCRF, and the type of eCRF (e.g., a screening form, a post-randomization form, a termination form).

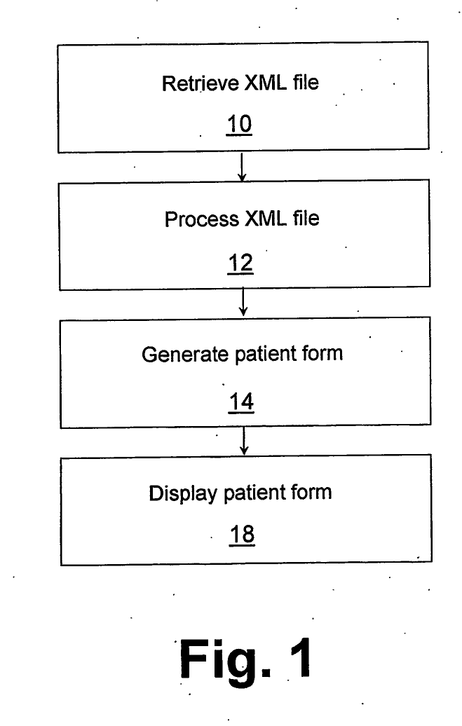

A method for generating and displaying a patient form is illustrated in FIG. 1. At step 10 of the method, an XML file is retrieved (the XML file detailing data and structure of a patient form) from a computer-readable medium. At step 12 of the method, the XML file is processed by running of an XML-responsive application. At step 14, the patient form (defined by the XML file) is generated. At step 18, the form is displayed on a display.

Within the eCRF specification are entries for each item within the form. An item may be a question or a heading. Information within the question entries can include the wording of the question, the type of question, the response categories, the coding scheme to be used for storing information in the database, enabled skip logic (dependencies on other questions), valid ranges, help information, consistency checks, calculations, missing data value, formatting information, annotation information, and the mapping to database tables and fields.

In addition to the XML specification allowing study coordinators to define the basic content and layout of their eCRFs, the XML specification also allows the specification of highly dynamic behavior that goes far beyond anything achievable using conventional paper-based forms. The XML specification allows the definition of boundary conditions for each response on the form which, when realized in a real-time response form, assist in preventing bad data at the source. The XML specification also allows automated skip logic to be defined and custom calculation scripts to be embedded in the electronic forms.

The XML specification holds customized scripting associated with various events that occur during the display of questions and the user Interaction with questions. The scripts implement custom functionality that cannot be specified through the standard XML schema. The scripts are device specific, in that part of the XML tags includes an indication of the target device. It will be appreciated that the scripting capabilities on different devices are not necessarily the same.

One possible XML specification in accordance with the document and data management system disclosed in this patent document is detailed in tables A-L.

A description of root node FormDefinition is provided in Table A below:

TABLE A
FormDefinition (Element) - definition
of the XML document (root node)

| Attributes | Type | Description |
|---|---|---|
| PenD_connectString | String | ODBC connection string to |
| | | CADB database |
| PenD_category | string | Category for all the forms in |
| | | this form definition |

A description of element Form is provided in Table B below:

TABLE B
Form (Element) - definition of a form

| Attributes | Type | Description |
|---|---|---|
| TableName | string | Name of the table in MS SQL Database |
| PDTableName | string | Name of the central table that holds all person/ |
| | | patient information |
| PDLookUP | Enumeration | Yes - Requires a lookup to the PDTableName |
| | | YesUpdate - This is a form that changes whether or |
| | | not the Patient/Person in included |
| | | No - Does not require a lookup to the PDTableName |
| | | NoCreate - Does not require a lookup to the patient |
| | | data table but creates an entry in the patient data |
| | | Table |
| FriendlyName | string | The name of the table show to the user |
| SummaryLabel | string | The label for displaying a record summary |
| SummaryField | string | The table field to display a record summary |
| PenD_FormHidden | Enumeration | Y - hide the form from user |
| | | N - show the form to the user |
| PenD_KeepDataOnPilot | Enumeration | −1 - keep data on the palm |
| | | 0 - don't keep data on the palm |
| PenD_export | Enumeration | −1 - distribute |
| | | 0 - development |
| PenD_formType | Enumeration | Usually set to 4 |
| PenD_sqlDownloadCriteria | string | Filename corresponding to the correct sqlDownload |
| | | Criteria for that form |
| | | sqlDownloadCriteria_Centers.inc - this is the |
| | | download criteria for a Centers form |
| | | sqlDownloadCriteria_PalmAccess Rights.inc-“ |
| | | PalmAccessRight form |
| | | sqlDownloadCriteria_PatientData.inc-“ PatientData |
| | | form |
| | | sqlDownloadCriteria_PatientStatus.inc-“ |
| | | PatientStatus form |
| | | sqlDownloadCriteria_Randomization.inc-“ |
| | | Randomization form |
| | | sqlDownloadCriteria_ScreeningInitial.inc-“ Screening |
| | | Initial form |
| | | sqlDownloadCriteria_allOthers.inc-“ All other Forms |
| CopyToSubform | string | Comma delimited string containing the question |
| | | variables that need to be copied from the parent |
| | | form to the subform |
| IsUnique | Enumeration | Yes (default) - indicated that this form can only have |
| | | one record for a particular patient |
| | | No - attribute indicating that the respective form |
| | | should allow duplicate entries for the respective |
| | | form, for the respective patient |
| FMode | Enumeration | ReadOnly - indicates that the entire form should be |
| | | read only |
| | | ReadWrite - indicates the form should behave |
| | | normally allowing updates, edits and inserts |
| | | (Palm\|Web)ReadOnly - indicates that the form is to |
| | | be read-only for either the palm or web, not both |
| FormID | string | A number - is the identifier of the form. This can be |
| | | generated dynamically or specified. (Currently only |
| | | used by Palm - NP/Jul. 24, 2003) |
| FConfirm Randomization | string | Y - indicates that this is the form creates the record |
| | | in the Randomization table and also changes the |
| | | WantToRand flag in the PatientData table to ‘Y’ |
| | | N - indicates that this form does not create a |
| | | Randomization record or change the WantToRand |
| | | flag in PatientData |

A description of element Question is provided in Table C below:

TABLE C
Question (Element) - definition of a question

| Attributes | Type | Description | |
|---|---|---|---|
| Qtype | Enumeration | Single - A question that can only have one | |
| | | response (ie. Radio button or drop down menu - | |
| | | See QDisplayType.) | |
| | | This type can be classified in pendragon as: | |
| | | Popup List | 6(Form Type) |
| | | Lookup List | 9 |
| | | Option 1 to 5 | 1 |
| | | Exclusive Lookup | 15 |
| | | Multiple - A question that can have many | |
| | | responses (ie. checkbox list) | |
| | | This type can be classified in pendragon as: | |
| | | Popup List | 22 |
| | | Text - a text area | |
| | | This type can be classified in pendragon as: | |
| | | FreeformText | 4 |
| | | Date - date/time field (currently six text boxes | |
| | | in the form dd/mm/yyy hh/mm/ss) | |
| | | This type can be classified in pendragon as: | |
| | | Date only | 21 |
| | | Time only | 13 |
| | | DateTime | 8 |
| | | Integer - a text field that only accepts integer | |
| | | values | |
| | | This type can be classified in pendragon as: | |
| | | Numeric | 5 |
| | | Decimal - a text field that accepts floats | |
| | | This type can be classified in pendragon as: | |
| | | Numeric | 5 |
| | | Heading - display text to user | |
| | | This type can be classified in pendragon as: | |
| | | Section | 10 |

| | | |
|---|---|---|
| QRequirement | Enumeration | Y - the question must be answered |
| | | N - this question is optional |
| QVariable | string | The column name (in MS SQL table) and the |
| | | pendragon script variable |
| | | Also used to reference a question in web forms |
| QText | string | Text to be displayed to the user |
| QOrientation | Enumeration | Horizontal - the questions are displayed |
| | | horizontally |
| | | Vertical - the questions are displayed |
| | | vertically |
| QVisible | Enumeration | Yes - The question is visible to the user |
| (DEPRECATED) | | No - The question is hidden from the user |
| QDependsOnQuestion | string | Variable that references a parent question |
| | | (QVariable Name), if it exists. Primarily used in |
| | | displaying and validated questions with skip |
| | | logic. |
| QDependsOnResponse | string | Variable that references a parent question |
| | | (QVariable Name), if it exists. If the correct |
| | | answer is selected in the parent question, the |
| | | current question is validated and displayed. For |
| | | multiple questions, responses are separated by a |
| | | colon (no space). |
| QDefaultVisibility | Enumeration | Show - Variable that indicates a question is to be |
| | | displayed upon first bringing up the form - |
| | | Necessary for SkipLogic questions |
| | | Hide - Variable that indicates a question is to be |
| | | hidden upon first bringing up the form - |
| | | Necessary for SkipLogic Questions |
| QID | string | The question ID |
| (DEPRECATED) | | |
| QFieldSize | string | The size and maxlength of a text field (the max |
| | | allowable characters for Qype = Text in Web |
| | | forms). |
| QMin | string | Sets the lower bound of a date, integer or |
| | | decimal answer |
| | | *NOTE: QMin is not implemented for Time fields |
| QMax | string | Set the upper bound of a date, integer or |
| | | decimal answer |
| | | *NOTE: QMax is not implemented for Time fields |
| QReadOnly | Enumeration | Y - field is read only |
| | | N - field is NOT read only |
| QDateTimeVisible | string | Both - Both date and time fields will be displayed |
| | | Time - Only time fields will be displayed |
| | | Date - (default) Only date fields will be displayed |
| | | • Note: Currently, you do not have to have this |
| | | attribute if the field is strictly a date field. |
| QDBTables | string | A “\|” delimited string of the extra tables that |
| | | need to be updated. (ie. PatientData) |
| QDBColumns | string | The columns to updated in QUpdateTable. |
| | | For more than one column per table, separate |
| | | the column names by a “,”. |
| | | If there is more than one table in QUpdateTable, |
| | | then separate all the columns of one table by a“\|”. |
| QDBAction | string | The type of database access (ie. Update, Insert) |
| QScreen | Enumeration | Inclusion - if this response category is selected, |
| | | the answer for this question satisfies inclusion |
| | | Exclusion - if this response category is selected, |
| | | the answer for this question satisfies exclusion |
| QScreenCompare | Enumeration | GT - Greater than |
| | | GTE - Greater than or Equal to |
| | | LT - Less than |
| | | LTE - Less than or Equal to |
| | | EQ - Equal to |
| QScreenValue | string | This is the actual value for screening purpose. |
| Q_PenD_FieldKey | Enumeration | −1 - this field is used as a display key |
| | | 0 - not a display key |
| Q_PenD_FieldPrimary | Enumeration | −1 - primary key |
| | | 0 - not primary key |
| Q_PenD_FormType | Enumeration | Enumeration for pendragon field types. See |
| | | Appendix A |
| Q_PenD_LookupName | string | Name of the pendragon lookup table. Applies to |
| | | form types 6, 9 and 15 |
| Q_PenD_PatternTex | string | Expected pattern of data. |
| Q_PenD_DefaultValue | string | Default value for the question. |
| Q_PenD_QuestionScript | string | Name of the file containing generated pendragon |
| | | script code. Created dynamically. |
| QDisplayType | string | To be used with QType = “Single” ONLY |
| | | OPTIONAL FIELD - if left blank, web forms will |
| | | assume radio buttons |
| | | Dropdown - this will display the responses in a |
| | | drop down menu |
| | | Radio - this will display the responses as a list |
| | | with radio buttons |

A description of element Response Category is provided in Table D below:

TABLE D
Response Category (Element) - a response to a question

| Attributes | Type | Description |
|---|---|---|
| RScreen | Enumeration | Inclusion - if this response category is |
| | | selected, the answer for this question |
| | | satisfies inclusion |
| | | Exclusion - if this response category is |
| | | selected, the answer for this question |
| | | satisfies exclusion |
| | | NA - used when the form is not a screening |
| | | form |
| RText | String | The text displayed for a radio button or |
| | | checkbox Also, the value to be stored in |
| | | the database if RValue is not specified. |
| | | *Do Not Use semi-colons (;) or colons (:) |
| | | in the RValue (used as a delimiter in web |
| | | forms) |
| RValue | String | The value associated with the specified |
| | | response category. ie) this could be used |
| | | to assign 1, 2, 3 and 4 to a |
| | | multiple-choice question |
| | | If this value is not specified, RText is |
| | | stored instead. |
| | | *Do Not Use semi-colons (;) or colons (:) |
| | | in the RValue (used as a delimiter in web |
| | | forms) |
| RID | String | An ID given to the question so its child, |
| | | sub-question, or subform can identify it. |

A description of element Other Category is provided in Table E below:

TABLE E
Other Category (Element) - a response to a question

| Attributes | Type | Description |
|---|---|---|
| OScreen | Enumeration | Inclusion - if this response category is |
| | | selected, the answer for this question |
| | | satisfies inclusion |
| | | Exclusion - if this response category is |
| | | selected, the answer for this question |
| | | satisfies exclusion |
| | | NA - used when the form is not a screening |
| | | form |
| OText | String | Text of questions |
| OValue | String | Value assigned to the response |
| OSize | String | Size of input field. |

A description of element Help is provided in Table F below:

TABLE F
Help (Element) - instructions/information regarding a question

| Attributes | Type | Description |
|---|---|---|
| HText | String | Text (instructions or information) |

A description of element PendragonScript is provided in Table G below:

TABLE G
PendragonScript (Element) - Pendragon question script
for a corresponding variable (aka field).

| Attributes | Type | Description |
|---|---|---|
| Name | String | Name of the PendragonScript element. |
| | | Corresponds to a QVariableName (aka Pendragon |
| | | Field Variable). This also can be the name of a |
| | | customize script which will be referred to in one of |
| | | the general templates. |

A description of element PendragonEvent is provided in Table H below:

TABLE H
PendragonEvent (Element) - Element that holds
the script code for a particular event.

| Attributes | Type | Description |
|---|---|---|
| Event | string | Name of the event. Can be a general event or a |
| | | customized event. General Pendragon Events are: |
| | | initialize, open, enter, select, exit, calculate, click, |
| | | validate. |

A description of element JavascriptFunction is provided in Table I below:

TABLE I
JavascriptFunction (Element) - Element that contains a generic script
(strictly for web forms. Does not include validation scripts).

| Attributes | Type | Description |
|---|---|---|
| JSFunctionName | string | Name of the function. |
| | | NOTE: For OnLoad events please use |
| | | JSFunctionName = “OnLoad” (these |
| | | functions will be placed at the END of the |
| | | form |
| | | For OnLoad events when UPDATING a form |
| | | (Correct CRF on Web) use JSFunctionName = |
| | | “OnLoadUpdate” |

A description of element JavascriptElement is provided in Table J below:

TABLE J
JavascriptElement (Element) - A script element
that holds the QVariableName of the corresponding
question (strictly for web forms).

| Attributes | Type | Description |
|---|---|---|
| JSName | string | Variable name of the question. Case-sensitive |
| JSFieldType | string | Indicates the type of field that is affected |
| | | (optional). |
| | | For Date and Time questions, there are three fields |
| | | per QVariableName. This attribute will take one of |
| | | the following values: day, month, year, hours, |
| | | minutes, seconds. |
| | | For Reset buttons, set JSFieldType to reset. |

A description of element JavascriptEvent is provided in Table K below:

TABLE K
Javascript Event (Element) - Element that holds the script
code for a particular event (strictly for web forms).

| Attributes | Type | Description |
|---|---|---|
| JSEvent | string | Name of the event. |
| | | General Javascript Events are: OnClick, |
| | | OnChange, OnLoad |
| | | For Single and Multiple QTypes use OnClick |
| | | For Integer, Decimal, Date and Text QTypes use |
| | | OnChange |
| | | OnLoad is used for Update and View functions |
| | | (web forms) |

A description of element DatabaseElement is provided in Table L below:

TABLE L
DatabaseElement (Element) - Element used to access a database (strictly for web
forms). - Currently ONLY used to populate hidden fields upon loading a form.

| Attributes | Type | Description |
|---|---|---|
| DBdatabase | string | Name of the database to be accessed |
| DBcolumns | string | Columns to be accessed. (Currently only works for |
| | | ONE column when DBaction = “SELECT”). |
| | | If more than one column, separate by “\|” |
| | | (Currently only works when DBaction = “UPDATE”). |
| | | If all, denote by “*”. |
| DBtable | string | Table to be accessed. |
| DBcriteria | string | Select/Update criteria |
| DBaction | string | The database table access type (update or select) |
| DBQVarName | string | The element (QVariableName) that is affected by |
| | | the database retrieval |

Changes and protocol amendments are constant throughout a clinical trial, and investigators expect rapid updates in the field. The ability to have one comprehensive specification for a CRF facilitates the updating of these forms.

A single specification ensures that there are no inconsistencies in forms across devices that are deployed in the field because all of the devices will use the same specification. The use of a single specification makes version control of forms very easy. Both of the above can assist in reducing the cost of conducting the trial and ensure the rapid propagation of changes.

Keeping forms up to date is also important in ensuring patient protection.

Having a single specification also makes it possible for non-developers to maintain the eCRF specifications themselves, hence offloading some of the trial maintenance and management tasks to less expensive resources. Again, this can lead to nontrivial reductions in cost and time for making changes during a trial.

Real-time interactive forms on possible interfaces such as a desktop browser or a PDA can be generated automatically from the XML specifications. In one embodiment this is done with a single click of the button. Preferably Web pages can be generated automatically when a page is requested. PDA forms are updated the next time a user performs a Hotsync™ on their device.

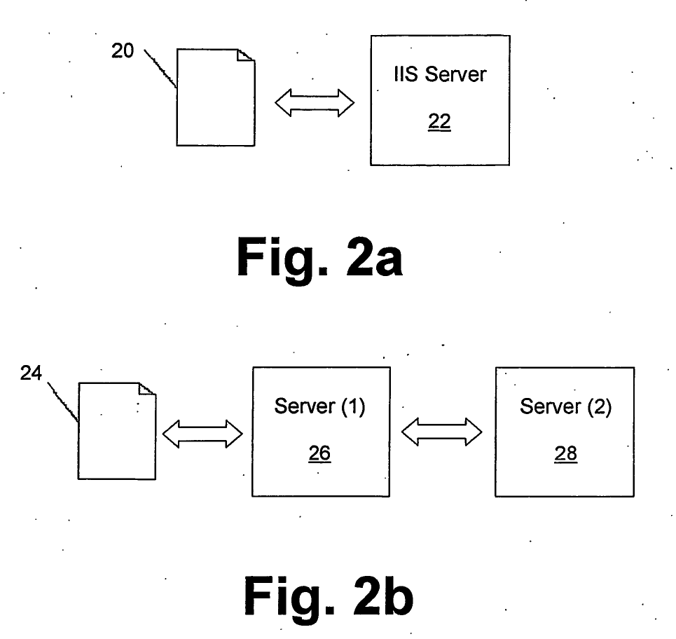

FIG. 2a is a diagram illustrating a relationship. More specifically, a dynamically generated, patient web form 20 interacts with a Microsoft Internet Information Services application server 22. In one embodiment, the form 20 comprises ASP, HTML and JavaScript code.

FIG. 2b is also a diagram illustrating a relationship. Dynamically generated, PDA patient form 24 interacts with a centralized synchronization server 26. The centralized synchronization server 26 in turn interacts with a centralized clinical analytics server 28.

Deploying case report forms, either on paper or electronically to multiple platforms is an operational, time consuming and error prone task. In an embodiment of the clinical analytics system disclosed in this patent document, using a single eCRF or collection of eCRFs generated with the XML specification, the system can automatically generate and deploy code for the eCRF to various platforms.

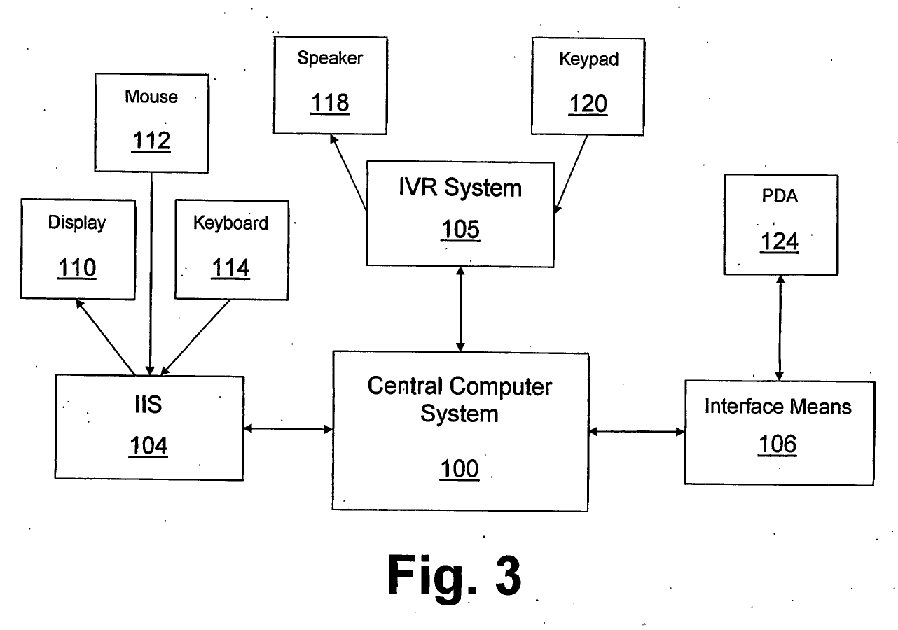

Referring to FIG. 3, central computer system 100 can automatically generate and deploy code for the eCRF to any one or more of Microsoft Internet Information Server 104, telephone interactive voice response (IVR) 105 and PDA interface means 106. Input to the central computer system 100 can be, depending on the platform, at least one of mouse 112, keyboard 114, telephone keypad 120 and input means of PDA 124. Output from the IIS 104 can be communicated to the user by display 110. Output from the IVR system 105 can be communicated to the user by telephone speaker 118. Output from the interface means 106 can be communicated to the user by the display of the PDA 124.

Because the clinical analytics system can automatically generate and deploy code for the eCRF to various platforms, once the form is authored or updated, investigators can have their new forms deployed to the field within minutes on both Palm and Web platforms. This represents a very significant time savings to investigators.

Making changes to and redeploying CRFs and eCRFs can be a large contributor to the operation cost of deploying a clinical trial. Trial sites (typically hospitals) tend to be geographically dispersed which complicates the distribution of updated forms in addition to the problem of assuring that all sites are using latest version forms. In less sophisticated electronic trial packages, changing electronic forms typically entails hand editing HTML and JavaScript® code, updating a database schema, recoding PDA software and having the sites update their installed software. This process can add months to the length of a clinical trial and can add a great deal of cost to the organization running it. The ability to quickly redeploy forms across all platforms can permit high cost savings as well as strategic and patient value in terms of completing trials more quickly. Also it can remove the risk that some investigators in the field may be working from outdated forms.

Randomization is one of the most critical activities in a clinical trial because this is what distinguishes it from less rigorous scientific methods. However, in clinical settings where nurses or research assistants need to randomize a new patient for entry into a trial, being able to randomize quickly using a mobile device is an advantageous.

Handheld randomization, according to an embodiment of the invention, entails a PDA connecting to a remote randomization server through a secure Internet connection and getting the next randomization number/code. The preferred system implementing randomization also verifies that the potential participant meets all inclusion criteria and does not meet any exclusion criteria. This provides an additional protection mechanism to avoid ineligible patients being enrolled in a trial. In a preferred implementation of the randomization method using a PDA, the process typically takes less than a minute.

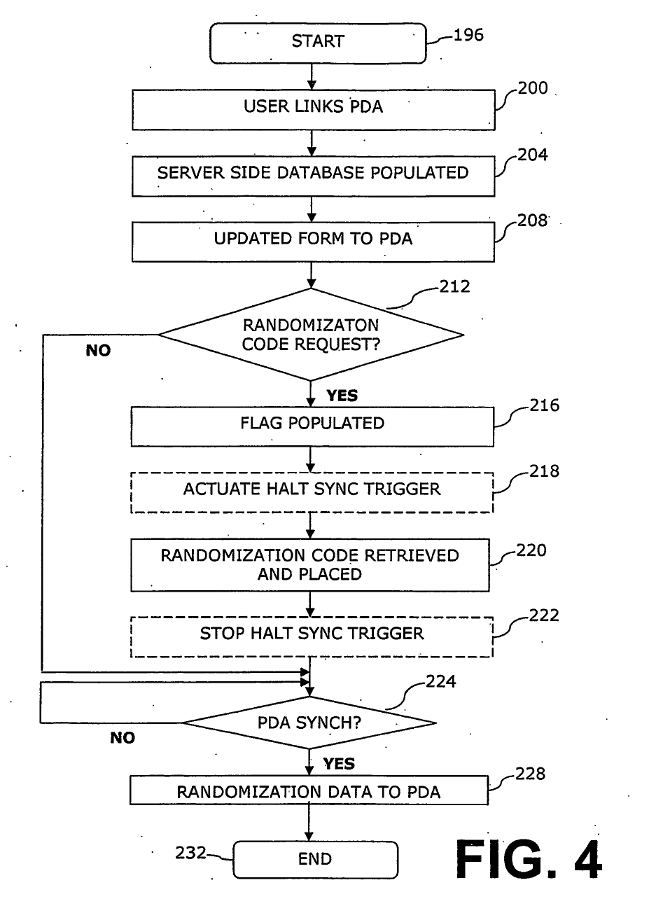

FIG. 4 illustrates two possible methodologies for handheld randomization. A first methodology includes all of the illustrated steps. A second methodology omits steps 218 and 222.

At step 200, a uset Hotsyncs™ their palm device, and a custom application is started on the randomization server.

At step 204, the server side database is populated with data from the palm based eCRFs.

At-step 208, updated form information is sent back to the Palm.

At step 212, steps 216 through 222 follow if the user has requested a randomization code or codes.

At step 216, a flag equating to a single data cell is transmitted and populated to the database.

At step 218, a second trigger associated with the randomization table is fired. The second trigger halts synchronization process until the new randomization code is populated in the patient record (step 220). Once this has occurred the second trigger terminates.

The next time the user synchronizes their Palm (step 224), the newly populated randomization data is sent to the Palm (step 228), to allow the user to determine if the patient is included or excluded.

In alternative embodiments of the randomization process disclosed in this patent document, the process is implemented through a web interface or through an automated phone system. In settings where there is a wireless network, the handheld randomization method can provide a high degree of flexibility.

A description of a possible implementation of the telephone automated central randomization embodiment of the invention is described in Table M below:

TABLE M

| | | User |
|---|---|---|
| | | Keypad |
| | Automated Message (Pseudo-code in square brackets) | Input |
| 1. | You have reached the ABC Research Group Central | |
| | Randomization Service. | |
| 2. | Using the keypad on your touch-tone phone, please enter | 13# |
| | the study code followed by the # key. | |
| 3. | [If they enter an invalid study code in 2: | |

“Invalid study code, 2 (or 1) tries left” If they
do this 3 times, “Your code seems to be invalid.
Please double check your study code and call back later.”

| | -- EXIT --] | |
|---|---|---|
| 4. | Please enter your authorization code followed by the # key. | 12345# |
| 5. | [If they enter an incorrect authorization code in 4: | |

“Invalid authorization code, 2 (or 1) tries left”
If they do this 3 times, “Your code seems to be
invalid. Please double check your study code and
authorization code and call back later.”
-- EXIT --]

| | | |
|---|---|---|
| 6. | Welcome to the VIP study. Please enter your center number | 01# |
| | followed by the # key. | |
| 7. | Hello center . If this is your correct center, press 1 followed by | 1# |
| | the # key. If this is not your correct center, press | |
| | 2 followed by the # key. | |
| 8. | [IF they press ‘2’ in (7): | |

Go To 6]

| | | |
|---|---|---|
| 9. | [IF they press ‘1’ in (7):] | 1# |

To randomize a new patient, please press 1 followed by
the # key. To hear the details of the last patient
randomized, please press 2 followed by the # key.

| | | |
|---|---|---|
| 10. | [IF they press ‘2’ in (9):] | 2# |

The last patient for this center was randomized at
<TIME> on <DATE>. The <StratificationVariable>
is XXX. Their randomization code is: XXXX.
..

If you would like to hear this again press 1 followed
by the # key. To exit press 2 followed by the # key.

| | |
|---|---|
| 11. | [IF they press ‘1’ in (10): |

Go To 10]

| | |
|---|---|
| 12. | [IF they press ‘2’ in (10): |

-- EXIT --]

| | | |
|---|---|---|
| 13. | [IF they press ‘1’ in (9):] | 18# |

Please enter the <StratificationVariable> followed
by the # key.

| | | |
|---|---|---|
| 14. | You have entered XX. To confirm this response, press 1 | 1# |
| | followed by the # key. To re-enter the | |
| | <StratificationVariable>, press 2 followed by the # key. | |
| 15. | [IF they press ‘2’ in (14): | |

Go To 13]

| | |
|---|---|
| 16. | [IF they press ‘1’ in (14) AND the |
| | <StratificationVariable> is out of range:] |

The <StratificationVariable> is out of range. Please
try again.
[Go To 13]

| | | |
|---|---|---|
| 17. | [IF they press ‘1’ in (14) AND the | 1# |
| | <StratificationVariable> is NOT out of range:] | |

Does this patient meet all of the inclusion criteria
for the Study? For yes, press 1 followed by the #
key. For no, press 2 followed by the # key.

| | | |
|---|---|---|
| 18. | You have entered Yes/No. To confirm this response, | 1# |
| | press 1 followed by the # key. To re-enter the | |
| | inclusion status, press 2 followed by the # key. | |
| 19. | [IF they press ‘2’ in (18): | |

Go To 17]

| | |
|---|---|
| 20. | [IF they have entered NO in (17) and ‘1’ in (18):] |
| | All patients must meet all inclusion criteria. Please |
| | try again or <EscapeMessage>. |

[GoTo 17]

| | | |
|---|---|---|
| 21. | [IF they have entered YES in (17) and ‘1’ in (18):] | 1# |

Are all of the exclusion criteria absent? For yes,
press 1 followed by the # key. For no, press 2
followed by the # key.

| | | |
|---|---|---|
| 22. | You have entered Yes/No. To confirm this response, | 1# |
| | press 1 followed by the # key. To re-enter the | |
| | exclusion status, press 2 followed by the # key. | |
| 23. | [If they press ‘2’ in (22): | |

Go To 21]

| | |
|---|---|
| 24. | [IF they have entered NO in (21) AND pressed ‘1’ in (22):] |

All patients must have all of the exclusion criteria
absent. Please try again or <EscapeMessage>.

[Go To 21]

| | | |
|---|---|---|
| 25. | [IF they have entered YES in (21) AND pressed ‘1’ in (22):] | 1# |

Has the consent been signed by the patient or the
patient's legal representative? For yes, press 1
followed by the # key. For no, press 2 followed by
the # key.

| | | |
|---|---|---|
| 26. | You have entered Yes/No. To confirm this response, | 1# |
| | press 1 followed by the # key. To re-enter the | |
| | consent status, press 2 followed by the # key. | |
| 27. | [If they press ‘2’ in (26): | |

Go To 25]

| | |
|---|---|
| 28. | [IF they have entered NO in (25) AND ‘1’ in (26):] |

All patients must give their consent. Please try again
or <EscapeMessage>.

[Go To 25]

| | | |
|---|---|---|
| 29. | [IF they have entered YES in (25) AND ‘1’ in (26):] | 1# |

Thank you, I will now summarize the information you
have just provided.
You are calling from center:
The <StratificationVariable> is: .

You have answered yes to the patient meeting all
inclusion criteria.

You have answered yes to all of the exclusion criteria
being absent.
You have answered yes to having the consent signed by
the patient or the patient's legal representative.
To confirm these responses, press 1 followed by the #
key. To re-enter press 2 followed by the # key. To
hear the summary again, press 3 followed by the # key.

| | |
|---|---|
| 30. | [IF they press ‘2’ in (29): |

Go To 13]

| | |
|---|---|
| 31. | [IF they press ‘3’ in (29): |

Go To 29]

| | |
|---|---|
| 32. | [IF they press ‘1’ in (29):] |

Please hold for the patient's randomization code.
This should take less than a minute. Please be ready
to record the randomization information.

| | | |
|---|---|---|
| 33. | The patient's randomization code is . | 2# |
| | I repeat - Patient Randomization code is . | |
| | The date of randomization is: . | |
| | The time of randomization is: . | |
| | If you wish to hear the randomization code again, press | |
| | 1 followed by the # key, otherwise to exit press 2 | |
| | followed by the # key. | |
| 34. | [IF they press ‘1’ in (33): | |

Go To 33]

| | |
|---|---|
| 35. | [IF they press ‘2’ in (33): |

Go To 36]

| | |
|---|---|
| 36. | <GoodbyeMessage> |

Handheld-based, web-based, and telephone-based randomization systems are preferably integrated such that the same sequence of randomization codes is used, irrespective of the device used for randomization. An embodiment of the present invention provides the capability to track randomization progress, irrespective of how randomization was performed.

Thus the end-user is given flexibility to randomize using the most convenient device. If the user is at his office in front of a desktop, then web randomization may be the best option. If in an intensive care unit where no Internet access is available and there is no wireless network, telephone randomization could be available. Finally, if the user is on rounds with no easy access to a desktop nor a telephone, randomization using a wireless handheld device could be available.

Regardless of whether a handheld-based, web-based or telephone-based system is used, the time and the user who performed the randomization is recorded. All of these systems can ensure allocation concealment, which is required in all randomized controlled trials.

There is a possibility that investigators may wish to use only the randomization features and not the data collection and management features. This can be accommodated. The ability to focus only on randomization allows hospitals to introduce electronic systems in their trials gradually as opposed to all at once. This may be advantageous in certain circumstances.

The ability to accurately and quickly randomize a patient from any location reduces the chances that an eligible participant is missed, and this helps ensure that the recruitment targets for a trial are met and that the trial finishes on time. Delays in trial completion can be very expensive for trial sponsors. In addition, the protection mechanisms for ensuing only eligible patients are enrolled can reduce the risks of harm to patients and provides a precise audit trail of all decisions that are made.

As a trial progress, it is important for site coordinators and research assistants to be able to monitor recruitment rates (overall and by center). It is also important to be able to track the exact status of each participant in the trial, which forms has that participant completed thus far, and what forms need to be completed.

A feature of the system disclosed in this patent document is precise tracking on the handheld. Users with appropriate permissions can find out the basic demographics for each patient, their randomization code/number, and which forms that have been completed thus far. In one embodiment, this information is updated on the handheld every time a Hotsync™ is done for the handheld.

For large trials where tens of forms have to be completed for each patient over an extended period of time that can last years, the traditional paper approach does not allow the site coordinators and research assistants to keep track in real-time of each patient. This becomes even more pronounced when there are multiple individuals entering data on the same patient with each holding a subset of the forms (i.e., lack of a centralized repository of information about each patient).

The regularly updated -handheld provides a capability that is not readily available otherwise. This can reduce the chances of errors. It will be appreciated that errors may harm the patient, for example, resulting in an unnecessary test/procedure because the nurse did not know that that data had already been collected. Other types of errors will simply waste time. For example, complete the same form more than once for the same patient. Still other errors will reduce data quality. For example, some forms could be missed altogether and this increases the chances that all data on that patient is wasted.

Because data is stored centrally, patient data can be tracked in real time both through the web and on the Palm. This allows study coordinators to monitor recruitment rates much more closely that with manual systems. It also adds significantly to patient protection since adverse events or trends can be recorded, tracked and acted on in real time. Again, this is very difficult to do with traditional systems.

An embodiment of the clinical analytics system disclosed in this patent document includes a software suite providing features that make it much easier for a large team of investigators and coordinators to collaborate in the conduct of a clinical trial. One implementation of the software suite comprises a forum with a fine permission structure, a secure instant messaging system among trial managers, a document management system that allows the categorizing and archiving of documents, and a version control system that allows multiple people to collaborate in the production of a document.

From a trial's inception there are many documents that are shared among the trial managers' and the investigators (the trial team). These can be drafts of the CRFs, drafts of the protocol, amendments, instructions to the sites, Research Ethics Board letters, and regulatory submissions. Some of these documents are sensitive and some are proprietary. Therefore, a secure way to collaborate and share this information from the inception of a trial is critical.

In the past the trial team exchanged documents by email. In addition to possible serious security problems that this entails, email does not easily control versions and stop multiple people from overwriting each other's work. Plus, email does not provide an audit trail. The same applies to discussions and communications among the trials team. Finally, material such as newsletters that is distributed to all of the sites gets lost in personal emails and becomes harder to find at a later date.

The integrated collaboration features in the software suite allow the trials team to post material to all of the sites and everyone one knows where that information is. The changes to that information are tracked throughout its history with versions and people who made changes. All of this is achieved in a secure environment. Permissions on who can read and edit each piece of information is controlled explicitly.

The first benefit from this software suite is that it helps manage the large amounts of documents that can be generated during a trial. This permits time saving by allowing users to find and search large amounts of information rather quickly. In addition, security can be provided within the clinical analytics system by ensuring that no proprietary information or private patient information is transmitted in open networks, so data is protected. This reduces the chances of breaking laws and regulations.

The integration of the software suite with the data collection and management system in the clinical analytics system means that users can manage the whole trial from one console without being required to switch systems or transfer data from one place to another. This reduces the training time and avoids a situation where secure information is being transferred between systems in an insecure fashion.

Many hospitals share information by having a shared drive that everyone can access. This results in confidential information being accessible by anyone and even worse, being modified and deleted by anyone. Since shared drives do not have a tracking mechanism, it can be difficult to recover changes as well as determine who has made what changes. This has resulted in the loss and corruption of data in the past, as well as security breaches. The clinical analytics system of the present invention moves the sites away from this archaic and dangerous way of managing information related to a trial.

A centralized data capture and management system provides a full transaction audit trail and backup system to ensure that a record of every transaction is kept and that data can always be restored if lost or damaged. This capability is far beyond what could be achieved with paper-based systems.

In an embodiment of the clinical analytics system of the present invention, the trial manager can compare in real-time the progress of all sites in a single table on various parameters. This real time ranking by recruitment rates, withdrawal rates, enrollment rates, meeting recruitment targets, and form completion statistics allows a project manager to immediately see which sites are performing well and which ones are under-performing. Such feedback allows the identification of site problems early and increases the chances of being able to take remedial action before a small problem puts the whole study in jeopardy.

The ability to identify issues, such as recruitment problems, early in a trial ensures that the trial managers can take remedial action and avoid failing to reach recruitment targets on time. This is critical for stakeholders and sponsors since delays in the completion of trials can be very costly.

In addition, the identification of remarkable results such as very rapid recruitment may be an indicator of problems such as data collection or data entry problems. Again, the ability to catch these at the very beginning of a study can ensure that fewer bad or unbelievable data are corrected and that staff are either trained or changed before small errors escalate.

Based on a specification which can be provided by the principal investigator, real-time validation of data as it is entered into the database is being performed. For example, checks are performed for unlikely values or for values that require immediate attention, for example, extreme values on certain measurements. These extreme values may be indicators of very sick patients or patients who need special attention.

The validation conditions are expressed as rules. These validation rules are implemented as database triggers that are customized for each trial and defined in the XML specification. In one embodiment whenever the rule is triggered, an email is sent to the person in charge to examine the data more carefully. This means that the availability of information is immediate. The same information can be sent to multiple people and through an internal instant messaging system.

From a patient protection and data quality perspective, the availability of real-time triggers is desirable. Potential patient safety problems are identified quickly, reducing the chances of harm being done. In addition, complex data quality validation rules can be checked every time a new data element is entered. It will be appreciated that a single data item for a patient being invalid can result in all of that patient's data being discarded. Therefore, good data quality reduces the chances of a trial being a failure. For example, if a large enough amount of patient data is discarded there will be insufficient statistical power to identify an effect even if one exists.

Based on a specification which can be provided by the principal investigator, real-time, client side validation of data as it is entered into an eCRF may be performed within the browser environment. For example, checks are performed for out-of-bounds values or for values that require correction. The eCRF evaluates data as it is input and alerts the user immediately if bad data is entered. The validation can be performed by JavaScript routines that are generated from the XML spec in real time as the page is displayed.

Catching data errors at the point of entry not only ensures better quality of data, it also makes the correction of bad data more efficient and less expensive. In addition, using eCRFs that provide immediate feedback helps to accelerate learning and adoption of the forms by investigators.

The modules forming the major components of the clinical analytics system have been so described and illustrated in the accompanying figures such that one skilled in the programming arts would be able to reproduce and gain the benefits of the invention. To further supplement the previous description and figures, the source code for an embodiment of the invention is provided.

Reference to a Computer Program Listing Compact Disk Appendix

A computer program listing appendix is included with this application and the entire contents of the computer program listing appendix is incorporated herein by reference.

Accompanying this application is a single CDROM which contains program listings which can be used to implement a preferred embodiment of the invention. The CDROM has 4 subdirectories: “ASP Source”, “FastDaemon”, “Telephone” and “XML Forms”. Due to the large quantity of files, amounting to a total of 387 files in all, the specific files in each of the directories and subdirectories are listed in an appendix at the end of this disclosure.

A portion of the disclosure recited in the specification contains material which is subject to copyright protection. Specifically, a Computer Program Listing Appendix is included that lists source code instructions for a process by which the present invention is practiced in a computer system. The copyright owner has no objection to the facsimile reproduction of the specification as filed. Otherwise all copyright rights are reserved.

While the invention has been described in conjunction with specific embodiments thereof, it is evident that many alternatives, modifications, and variations will be apparent to those skilled in the art in light of the foregoing description. Accordingly, it is intended that the present invention be limited not by the specific disclosure herein, but to embrace all such alternatives, modifications, and variations as fall within the spirit and broad scope of the appended claims.

What is claimed is:

1. A method for generating and displaying a patient form, the method comprising:
retreiving an XML file from a computer-readable medium, said XML file detailing data and structure of said patient form;
processing said XML file by running of an XML-responsive application;
generating said patient form defined by said XML file; and
displaying said form on a display.

2. A method according to claim 1, wherein said computer-readable medium is random access memory.

3. A method according to claim 1, wherein said patient form is an interactive patient form.

4. Method according to claim 1, wherein said patient form is a real-time interactive patient form.

5. Method according to claim 1, wherein said patient form is a clinical trial form.

6. Method according to claim 5, wherein said clinical trial form is a screening form.

7. A method according to claim 5, wherein said clinical trial form is a post-randomization form.

8. A method according to claim 5, wherein said clinical trial form is a termination form.

9. A computer program product containing a software program for installation in a central computer system that is connected to a network, the software program comprising:
code for generating code for a patient form, said patient form defined by an XML file.

10. A computer program product according to claim 9, wherein said software program further comprises code for network deployment of said code for a patient form.

11. A computer program product according to claim 9 or 10, wherein said patient form is an interactive patient form.

12. A computer program product according to claim 9 or 10, wherein said patient form is a real-time interactive patient form.

13. A method according to claim 9 or 10, wherein said patient form is a clinical trial form.

14. A method according to claim 13, wherein said clinical trial form is a screen form.

15. A method according to claim 13, wherein said clinical trial form is a post randomization form.

16. A computer program product according to claim 13, wherein said clinical trial-form is a termination form.

17. A computer program product comprising:
a software program comprising code for generating code for a patient form, said patient form defined by an XML file, said software program for installation in a central computer system that is connected to a network.

18. Computer program product according to claim 17, wherein said software program further comprises code for network deployment of code for a patient form.
